(19) United States
(12) Patent Application Publication
(10) Pub. No.: US 2021/0381420 A1
(43) Pub. Date: Dec. 9, 2021

(54) PUMP GROUP

(71) Applicant: Industrie Saleri Italo S.p.A., Lumezzane (Brescia) (IT)

(72) Inventors: Alfonso SURACE, Lumezzane (Brescia) (IT); Marco PEDERSOLI, Lumezzane (Brescia) (IT)

(21) Appl. No.: 17/282,475

(22) PCT Filed: Jun. 14, 2019
(86) PCT No.: PCT/IB2019/054983

§ 371 Date: Apr. 2, 2021

(30) Foreign Application Priority Data
Oct. 5, 2018 (IT) 102018000009201

(51) Int. Cl. F01P 3/20; F01P 5/12

(52) U.S. Cl. CPC F01P 3/20; F01P 2003/006; F01P 5/12

(57) ABSTRACT

A pump group of a cooling system of a vehicle engine is provided. The pump group extends with respect to an axis (X-X) and has an impeller, a shaft, the impeller being integrally mounted on the shaft, an electric motor having a rotor integrally mounted on the shaft and a stator. A pump body, extending with respect to the axis (X-X), has an impeller casing housing the impeller in an impeller chamber, and a motor casing housing the electric motor in a motor chamber. The motor casing has an intermediate tubular wall positioned between the rotor and the stator so as to define a rotor chamber and a stator chamber sealingly separated from each other. The stator chamber contains a predefined amount of cooling oil, the predefined amount of cooling oil at least partially filling the stator chamber so that the stator is cooled by convection.

The present invention concerns a pump group for an engine cooling system of a vehicle. In particular, this cooling system is specific to the cooling of the engine, for example, but not necessarily, the internal combustion engine, of the vehicle.

In the state of the art there are many known embodiments of pump groups for an engine cooling system that differ from each other in size and type of drive.

Specifically, the pump group, object of the present invention, is placed in this context, having an electric-type drive. In other words, the pump group, object of the present invention, comprises at least one electric motor which controls the rotary movement of the impeller comprised therein, thus driving the movement of the cooling liquid which flows into the cooling system to which the pump group may be fluidically connected.

A variety of technical solutions for pump groups are known, comprising an electric drive, in which the main problem of this type of pump group has been addressed, namely the need to effectively cool the electric motor and the components thereof.

In particular, there are known embodiments of pump groups in which the cooling liquid present in the chamber where the impeller is housed is used to cool also the electric motor and the components thereof, in particular the rotor comprised therein.

On the other hand, these embodiments have a complex structure and, above all, do not provide particularly effective cooling.

The object of the present invention is to provide a pump group for an engine cooling system that provides effective cooling of the electric drive and in particular of the electric motor thereof, in particular of the stator thereof, resolving the aforesaid problem.

Such object is achieved by a pump group according to claim 1. The claims dependent on this claim refer to preferred variant embodiments, having further advantageous aspects.

The object of the present invention is hereinafter described in detail with the aid of the accompanying figures, wherein:

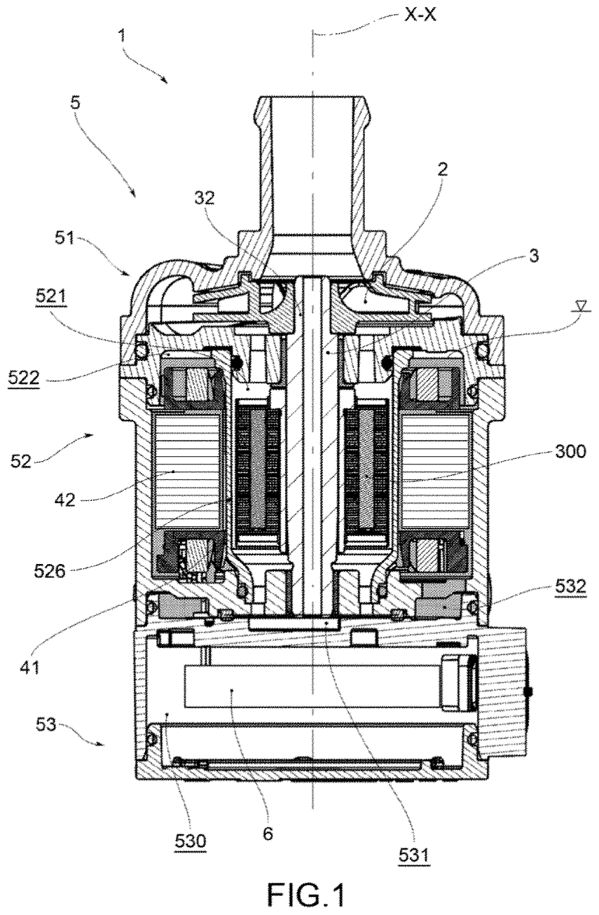

FIG. 1 illustrates a longitudinal sectional view of a pump group in accordance with the present invention, according to one possible embodiment;

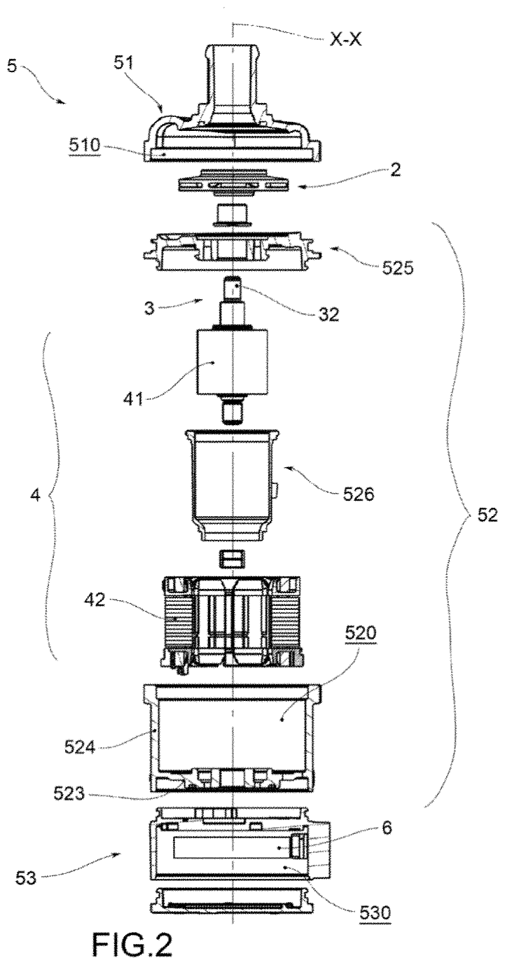

FIG. 2 shows a longitudinal sectional view in separate parts of the pump group of FIG. 1.

In the aforesaid figures, a pump group for a cooling system of an engine of a vehicle, preferably for cooling the engine, for example an internal combustion engine, is indicated collectively at reference number 1.

The pump group 1, which is the object of the present invention, preferably extends in length with respect to an axis X-X.

The pump group 1, object of the present invention, comprises an impeller 2 rotatable with respect to said axis X-X. In other words, said impeller 2 has a center of rotation that lies on said axis X-X.

Preferably, the impeller 2 is of the radial type, being specially designed to perform a suction action on the cooling liquid preferably in the axial direction and to perform a thrust action preferably in the radial direction.

Moreover, according to the present invention, the pump group 1 comprises a shaft 3 that extends in length along the axis X-X. Preferably, said shaft 3 comprises an impeller end 32 on which is integrally mounted the impeller 2.

According to the present invention, the pump group 1 comprises an electric motor 4 suitable to control the shaft 3 in rotation.

The electric motor 4 comprises a rotor 41 and a stator 42. According to a preferred embodiment, the rotor 41 and the stator 42 are arranged concentrically in relation to the axis X-X.

According to the present invention, the rotor 41 is integrally mounted, for example fitted, to said shaft 3: the rotation of the shaft 3, and in turn of the impeller 2, corresponds to the electronically controlled rotation of the rotor 41. The stator 42 surrounds the rotor 41 axially and circumferentially. In particular, the stator 42 comprises a plurality of stator coils forming stator poles.

According to the present invention, the pump group 1 comprises a pump body 5 extending with respect to the axis X-X, suitable to contain the various operating components of the pump group 1 and suitable to be fluidically connected to the vehicle's cooling system.

The pump body 5 in effect comprises an impeller casing 51 in which the impeller 2 is housed in an impeller chamber 510. The impeller casing 51 is in effect fluidically connected to the cooling system ducts.

In addition, the pump body 5 also comprises a motor casing 52 in which the electric motor 4 is housed. In particular, the motor casing 52 comprises a motor chamber 520 in which the rotor 41 and the stator 42 are housed.

According to a preferred embodiment, the motor casing 52 comprises a bottom wall 523 and side walls 524 extending in height from said bottom wall 523, preferably parallel to the axis X-X.

In addition, preferably, the motor casing 52 comprises a closing plate 525 that engages the side walls 524 to close and delimit the motor chamber 520.

It should be noted, as shown by way of example, and evident from what is described hereinafter, how some of the aforesaid components (the bottom wall 523, the side walls 524, the closing plate 525 may have specially shaped openings, for example for the fluidic passage or for the passage or support of the shaft 3). The motor casing 2 supports the shaft 3 in free rotation: specifically said bottom wall 523 and said closing plate 525 comprise specially shaped support and/or connection portions (e.g. housing a sliding member such as a brass bearing) especially suited to support the shaft 3 in free rotation around the axis X-X.

In addition, according to the present invention, the motor casing 52 comprises an intermediate tubular wall 526 extending parallel to the axis X-X positioned in an intermediate radial position between the rotor 41 and the stator 42.

The intermediate tubular wall 526 subdivides in the motor chamber 52 a rotor chamber 521 and a stator chamber 522. In other words, the motor chamber 520 is divided into a rotor chamber 521 and a stator chamber 522.

The rotor chamber 521 and the stator chamber 522 are sealingly separated from each other.

According to the present invention, the stator chamber 522 contains a predefined amount of cooling oil. In particular, said predefined amount of cooling oil fills at least in part said stator chamber 522 so that the stator 42 is cooled by convection. In other words, the predefined amount of cooling oil fills at least in part the vacant space present in said stator chamber 522, i.e. the space not occupied by the stator 42.

According to a preferred embodiment, said cooling oil is of the dielectric type. In other words, said cooling oil is an electrical insulator. In still other words, electrical conduction is avoided in the cooling oil.

According to a preferred embodiment, the predefined amount of cooling oil fills a part of the stator chamber 522 defining a free surface. In this way at least one part of the stator chamber 522 is empty (i.e. there is air in at least one part of the stator chamber 522). In other words, at least a part of the stator chamber 522 defines a vacant volume.

Preferably, this vacant space is suitable to compensate for any thermal volumetric expansion of the materials, of the stator and/or of the pump group, and of the oil.

In addition, owing to the presence of the aforesaid vacant space, when the pump group 1 is subject to shaking, for example due to the motion of the vehicle, the cooling oil is free to move in the stator chamber 522, promoting a cooling of the stator 42 by forced convection.

According to a preferred embodiment, the predefined amount of cooling oil fills the stator chamber 522 so as to wet all the free surfaces of said coils, for example having a free surface at an axial height greater than the stator 42.

In other words, the entire stator 42 is in an oil bath.

According to the present invention, the presence of the cooling oil in the stator chamber guarantees a cooling of the same according to natural convection, for example in static phases of the vehicle, and according to forced convection, for example in motion phases of the vehicle.

According to a preferred embodiment, the intermediate tubular wall 526 extends axially comprising a first end 526′ which sealingly engages the bottom wall 523 and a second end 526″ which sealingly engages the closing plate 525. In other words, the intermediate tubular wall 526 may be mounted in the motor chamber.

According to other variant embodiments, the intermediate tubular wall 526 has one of said ends integral with the bottom wall 523 or with the closing plate 525.

According to a preferred embodiment, the rotor chamber 521 is fluidically connected with the impeller chamber 51 so that cooling liquid flows into said rotor chamber 521.

Preferably, the shaft 3 comprises an axial through hole 300 through which the cooling liquid flows.

According to a preferred embodiment, the pump body 5 comprises a control casing 53 housing an electronic control unit 6 connected to the electric motor 4. In other words, the pump group 1 comprises said electronic control unit 6, which controls the electric motor 4, and in particular the stator 42 thereof.

According to a preferred embodiment, the control casing 53 comprises a control chamber 530 in which is housed said electronic control unit 6.

According to a preferred embodiment, the control casing 53 is sealingly mounted on the motor casing 52. Preferably, the control casing 53 is mounted axially opposite the impeller casing.

According to a preferred embodiment, moreover, the control casing 53 and the motor casing 52 delimit an auxiliary cooling chamber 532, fluidically connected to the stator chamber 522 so that also said auxiliary cooling chamber 532 contains cooling oil.

Moreover, according to a preferred embodiment, the control casing 53 and the motor casing 52 delimit a second auxiliary cooling chamber 531 fluidically connected to the rotor chamber 521 so that also said second auxiliary cooling chamber 531 is fluidically reached by cooling liquid.

According to a preferred embodiment, the pump group 1 object of the present invention is of the dual type, comprising, in addition to the electric drive, a mechanical drive that in turn acts on the shaft 3.

Also an object of the present invention is an assembly method of a pump group 1 in accordance with that which is described above. Said method is characterized by the step of pouring a predefined quantity of cooling oil into the stator chamber 522.

In particular, said assembly method first of all provides for the step of inserting the stator 42 in the motor chamber 520, preferably in the stator chamber 522.

Once the predefined amount of cooling oil has been poured into the stator chamber 522, in a preferred embodiment of the cooling method, the step of sealingly mounting the closing plate 525 is carried out, in order to seal the stator chamber 522.

Otherwise, in a preferred embodiment, wherein the closing plate 525 is already mounted, and the oil is thus poured through an opening in the bottom wall 523, the step of sealingly mounting the control casing 53 on the motor casing 52 is provided.

Innovatively, the pump group object of the present invention satisfies the cooling requirements of the electric motor and overcomes the drawbacks pertaining to the solutions of the state-of-the-art mentioned above.

Advantageously, the pump group, object of the present invention, provides a cooling of the electric motor, and in particular of the stator thereof, that is particularly efficient.

Advantageously, the stator operates effectively, and the yield of the electric motor is greater. Advantageously, the stator is cooled effectively due to the presence of the cooling oil.

Advantageously, the stator is effectively cooled by natural convection and/or forced convection. Advantageously, the stator is cooled effectively both in static vehicle situations and in dynamic vehicle situations.

Advantageously, the predefined quantity of oil in the stator chamber is such as to allow and compensate for any thermal expansion of the stator, the pump group and/or the cooling oil and at the same time to reduce the spaces in the stator chamber.

Advantageously, the pump group has a simple and compact shape and size. Advantageously, in effect, the pump group does not require specific components for cooling the electric motor and in particular the stator.

Advantageously, an embodiment of a dual pump group that makes full use of the aforesaid advantages is foreseeable.

It is clear that a person skilled in the art, in order to meet contingent needs, may make changes to the pump group, all contained within the scope of protection as defined by the following claims.

Moreover, each variant described as belonging to a possible embodiment may be implemented independently of the other variants described.

What is claimed is:

1-15. (canceled)

16. A pump group of a cooling system of a vehicle engine, the pump group extending with respect to an axis (X-X) and comprising:
an impeller rotatable around the axis (X-X);
a shaft extending along the axis (X-X) and comprising an impeller end, the impeller being integrally mounted on the impeller end;
an electric motor comprising a rotor integrally mounted on the shaft and a stator surrounding the rotor axially and circumferentially;
a pump body extending with respect to the axis (X-X), the pump body comprising:
an impeller casing housing the impeller in an impeller chamber; and
a motor casing housing the electric motor in a motor chamber, wherein the motor casing comprises an intermediate tubular wall extending parallel to the axis (X-X), the intermediate tubular wall being positioned in an intermediate radial position between the rotor and the stator, so that a rotor chamber and a stator chamber are defined in the motor casing;
wherein the rotor chamber and the stator chamber are sealingly separated from each other, wherein the stator chamber contains a predefined amount of cooling oil, said predefined amount of cooling oil at least partially filling the stator chamber so as to cool the stator by convection, and wherein the predetermined amount of cooling oil fills a part of the stator chamber defining a free surface, such that, with the pump group subjected to shaking due to motion of the vehicle, the cooling oil is free to move in the stator chamber promoting cooling of the stator by forced convection.

17. The pump group of claim 16, wherein said cooling oil is of dielectric type.

18. The pump group of claim 16, wherein the stator comprises a plurality of stator coils forming stator poles, wherein said predetermined amount of cooling oil fills the stator chamber so as to wet all free surfaces of said stator coils, having a free surface at an axial height greater than the stator.

19. The pump group of claim 16, wherein the motor casing comprises a bottom wall and side walls, said side walls extending in height, wherein the motor casing comprises a closing plate sealingly engaging the side walls to close and delimit the motor chamber.

20. The pump group of claim 16, wherein the intermediate tubular wall extends axially and comprises a first end that sealingly engages the bottom wall, and a second end that sealingly engages the closing plate.

21. The pump group of claim 16, wherein the rotor chamber is fluidically connected to the impeller chamber so that cooling oil flows into said rotor chamber.

22. The pump group of claim 21, wherein the shaft comprises an axial through hole through which cooling oil flows.

23. The pump group of claim 16, wherein the pump body comprises a control casing that defines a control chamber housing an electronic control unit, connected to the electric motor, and wherein said control casing is sealingly mounted on the motor casing.

24. The pump group of claim 23, wherein the control casing and the motor casing delimit an auxiliary cooling chamber fluidically connected to the stator chamber so that also said auxiliary cooling chamber contains cooling oil.

25. The pump group of claim 24, wherein the rotor chamber is fluidically connected to the impeller chamber so that cooling oil flows into said rotor chamber, and wherein the control casing and the motor casing delimit a second auxiliary cooling chamber fluidically connected to the rotor chamber so that said second auxiliary cooling chamber is also fluidically reached by cooling oil.

26. The pump group of claim 16, further comprising a mechanical drive operatively connected to the shaft to control rotation of the shaft with or in place of the electric motor.

27. A method for assembling a pump group of a cooling system of a vehicle engine, the pump group extending with respect to an axis (X-X) and comprising:
an impeller rotatable around the axis (X-X);
a shaft extending along the axis (X-X) and comprising an impeller end, the impeller being integrally mounted on the impeller end;
an electric motor comprising a rotor integrally mounted on the shaft and a stator surrounding the rotor axially and circumferentially;
a pump body extending with respect to the axis (X-X), the pump body comprising:
an impeller casing housing the impeller in an impeller chamber; and
a motor casing housing the electric motor in a motor chamber, wherein the motor casing comprises an intermediate tubular wall extending parallel to the axis (X-X), the intermediate tubular wall being positioned in an intermediate radial position between the rotor and the stator, so that a rotor chamber and a stator chamber are defined in the motor casing;
wherein the rotor chamber and the stator chamber are sealingly separated from each other, wherein the stator chamber contains a predefined amount of cooling oil, said predefined amount of cooling oil at least partially filling the stator chamber so as to cool the stator by convection, and wherein the predetermined amount of cooling oil fills a part of the stator chamber defining a free surface, such that, with the pump group subjected to shaking due to motion of the vehicle, the cooling oil is free to move in the stator chamber promoting cooling of the stator by forced convection,
the method comprising pouring a predefined amount of cooling oil in the stator chamber.

28. The method of claim 27, wherein the motor casing comprises a bottom wall and side walls, said side walls extending in height, wherein the motor casing comprises a closing plate sealingly engaging the side walls to close and delimit the motor chamber, the method comprising:
inserting the stator in the stator chamber;
pouring a predefined amount of cooling oil in the stator chamber; and
sealingly mounting the closing plate to seal the stator chamber.

29. The method of claim 27, wherein the pump body comprises a control casing that defines a control chamber housing an electronic control unit, connected to the electric motor, wherein said control casing is sealingly mounted on the motor casing, wherein the control casing and the motor casing delimit an auxiliary cooling chamber fluidically connected to the stator chamber so that also said auxiliary cooling chamber contains cooling oil, wherein the rotor chamber is fluidically connected to the impeller chamber so that cooling oil flows into said rotor chamber, and wherein the control casing and the motor casing delimit a second auxiliary cooling chamber fluidically connected to the rotor chamber so that said second auxiliary cooling chamber is also fluidically reached by cooling oil, the method comprising:
inserting the stator in the stator chamber;
sealingly mounting the closing plate to seal the stator chamber;
pouring a predefined amount of cooling oil in the stator chamber; and
sealingly mounting the control casing on the motor casing.
